(19) United States
(12) Patent Application Publication
(10) Pub. No.: US 2020/0277005 A1
(43) Pub. Date: Sep. 3, 2020

(54) USE OF AN ASSIST MOTOR OF A POWER STEERING SYSTEM TO GENERATE TEST CYCLES ACCORDING TO A POSITION ASCERTAINING CYCLE

(71) Applicant: JTEKT EUROPE, Irigny (FR)

(72) Inventors: Matthieu LOUSSAUT, Tassin-la-Demi-Lune (FR); Christophe RAVIER, Saint Pierre de Chandieu (FR)

(73) Assignee: JTEKT EUROPE, Irigny (FR)

(21) Appl. No.: 16/764,266

(22) PCT Filed: Dec. 3, 2018
(86) PCT No.: PCT/FR2018/053088

§ 371 Date: May 14, 2020

(30) Foreign Application Priority Data
Dec. 7, 2017 (FR) 17/61764

(51) Int. Cl. B62D 5/04; B62D 15/02

(52) U.S. Cl. CPC B62D 5/0463; B62D 15/021; B62D 5/0487

(57) ABSTRACT

A method for a power steering system for empirically determining at least one property of the system including at least one steering wheel, a steering mechanism with a rack, and at least one assist motor, the method including, outside a steering phase during which the power steering system is assigned to drive a vehicle to follow a trajectory determined as a situation function of the vehicle with respect to its environment, a step (a) of automatically activating the assist motor, during which a computer automatically generates and applies to the assistance motor, without requiring action on the steering wheel, an activation instruction following one or more pre-established exploration cycles for measuring, during or at the end of the at least one exploration cycle, at least one indicator parameter is specific to the power steering system response to the automatic activation of the assist motor and is a desired property characteristic.

The present invention concerns the characterization methods intended to empirically determine at least one property of a power steering system, such as for example the position of the end-of-stroke stops of a steering rack or else the frequency response characteristics of the power steering system, when the system is developed or calibrated in the factory.

The known characterization methods require that a human operator installs the power steering system on a test bench, then maneuvers the steering wheel according to pre-established special maneuvering cycles, so that sensors and recorders which equip the test bench can observe the reactions of the steering system and measure the indicator parameters which then allow quantifying the desired property.

Of course, such manual maneuvers are sometimes quite tedious, and often relatively inaccurate, insofar as the operator cannot exert, in a reliable and reproducible manner, an accurate speed or force setpoint, and in particular a constant value setpoint, or else can, for example, mistake the direction of maneuver during a cycle, which may distort the estimate of the desired property.

Moreover, if it is conceivable, in absolute terms, to replace the operator with a robotic arm which actuates the steering wheel, such a solution is particularly complex and expensive to implement, in particular because it is necessary for each test to install and couple the robotic arm to the steering wheel, and to physically reconfigure the robotic arm and the test bench depending on the tested steering system model.

The objects assigned to the invention consequently aim at overcoming the aforementioned drawbacks and at proposing a method for characterizing a power steering system which allows a fast, reliable and low cost characterization of said power steering system.

The objects assigned to the invention also aim at proposing a new method for characterizing a power steering system which has a great versatility, in that said method is adapted in a simple manner to many models of power steering systems and/or allows completely characterizing several properties of the same power steering system.

The objects assigned to the invention are achieved by means of a method for characterizing a power steering system intended to empirically determine at least one property of said power steering system, called « desired property », said power steering system comprising at least one heading definition device, such as a steering wheel, which allows defining the orientation, called « steering angle », of the power steering system, a steering mechanism provided with at least one movable member, such as a rack, whose position is adapted so as to correspond to the chosen steering angle, as well as at least one assist motor arranged to be able to drive said steering mechanism, said method being characterized in that it comprises, apart from a control phase during which the power steering system is assigned to driving a vehicle in order to make said vehicle follow a trajectory which is determined depending on the situation of said vehicle relative to its environment, a step (a) of automatic activation of the assist motor, during which a computer is used to automatically generate and apply to the assist motor, without requiring an external action on the heading definition device, an activation setpoint which follows one or several cycle(s) called pre-established « scanning cycles », a measurement step (b), according to which, during the scanning cycle(s) or at the end of said scanning cycle(s), at least one physical parameter, called « indicator parameter », is measured, which is specific to the response provided by the power steering system upon automatic activation of the assist motor and which is characteristic of the desired property, then an analysis step (c), during which the desired property is quantified from the measurement(s) of the indicator parameter.

Advantageously, the invention thus uses the assist motor itself as (unique) means for activating the steering mechanism according to the chosen scanning cycle(s), without the need to use auxiliary drive means, and in particular an auxiliary motor, external to the steering system.

An operator or a robotic arm is thus saved.

Furthermore, the automation of the scanning cycles advantageously allows applying to the assist motor, during the phases in which the steering system is characterized, particularly accurate setpoints, much more accurate than during manual maneuvers, and in particular constant speed, acceleration or force setpoints for predetermined durations or over predetermined displacement distances of the movable member, which allows accurately measuring the indicator parameter (s), without the activation the power steering system itself constituting a potential source of error which would be linked to an excessive and uncontrolled variability of the setpoint relative to the targeted ideal scanning cycle.

The characterization of the desired property is therefore particularly accurate and reproducible.

Furthermore, the invention allows in particular equipping the power steering system, regardless of the model of said system, with an on-board calculation module which contains a complete set of characterization functions, for example in the form of a library file stored in a non-volatile memory of said module, such that the power steering system will be intrinsically provided with the tools necessary for its characterization, and more generally for the characterization of several of the properties thereof.

The development and calibration of said power steering system will therefore be greatly facilitated.

Other objects, features and advantages of the invention will appear in more detail on reading the following description, as well as using the appended drawings, provided for purely illustrative and non-limiting purposes, among which:

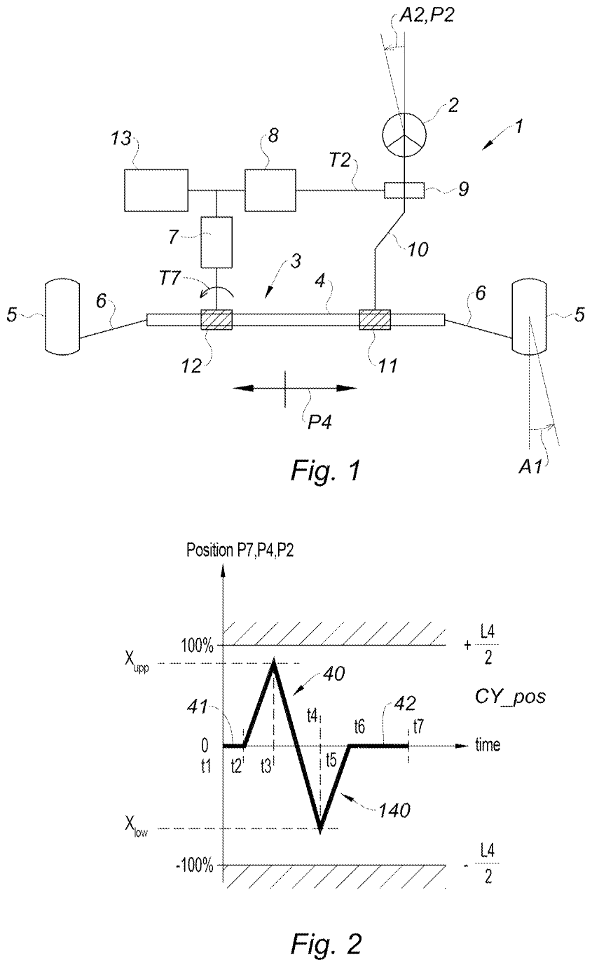

FIG. 1 illustrates, in a schematic view, a power steering system.

FIG. 2 illustrates an example of a position scanning cycle, according to which the position assist motor is servo-controlled in order to alternatively shift the steering mechanism from a first extreme position to a second extreme position, and that it can for example be repeated in large numbers to test the endurance of the steering mechanism.

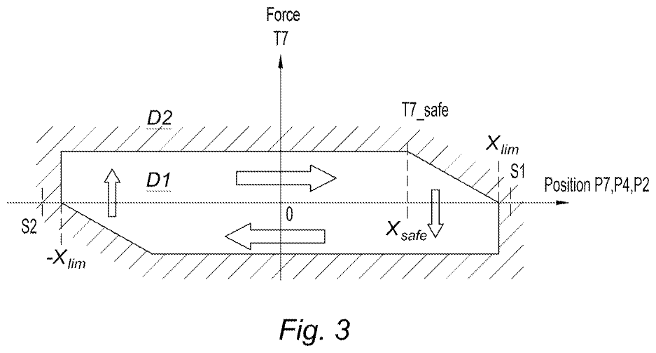

FIG. 3 illustrates a security function which, by being superimposed, if necessary, on the scanning cycles, allows limiting the torque developed by the assist motor when the steering mechanism approaches the end-of-stroke stops.

The invention concerns a method for characterizing a power steering system 1 intended to empirically determine at least one property of said power steering system 1, specific to said system, called « desired property ».

As shown in FIG. 1, said power steering system 1 comprises at least one heading definition device 2 which allows defining the orientation, called « a steering angle » A1 of the power steering system.

Preferably, the heading definition device 2 will comprise a steering wheel 2 which allows a (human) driver to freely define said steering angle A1 to ensure a manual control of a vehicle equipped with the power steering system 1.

Said steering system also comprises a steering mechanism 3 provided with at least one movable member 4, such as a rack 4, whose position P4 is adapted so as to correspond to the chosen steering angle.

For convenience, the movable member 4 could therefore be assimilated to a rack in the following.

In a manner known per se, said movable member 4, and more particularly the rack 4, could preferably be movably mounted and guided in translation in a steering casing.

The steering mechanism 3 thus allows modifying the orientation of an orientable member 5, such as a steered wheel 5, driven in displacement by the rack 4, in order to steer a vehicle on which said power steering system 1 is on-board.

In a manner known per se, the steering mechanism 3 might include steering tie rods 6 which each connect one end of the rack 4 to a yaw-orientable steering knuckle and carrying the corresponding steered wheel 5.

The power steering system 1 also comprises at least one assist motor 7 arranged to be able to drive said steering mechanism 3.

Said assist motor 7 will preferably be an electric motor operating in both directions in order to be able to drive the steering mechanism 3 either to the left or to the right, for example a brushless motor.

Although it is not excluded to use a linear motor 7, a rotary motor 7 will be preferred.

The assist motor 7 is placed, via a computer comprising a first on-board module 8, that is to say forming an integral part of the system 1, called « assist module » 8, under the dependence of the heading definition device 2.

The heading definition apparatus 2 can preferably be used to define a steering angle setpoint A2, which could typically be defined, in the case where the apparatus 2 comprises a steering wheel 2 or is formed by a steering wheel 2, by the angular position P2 of said steering wheel 2.

In an alternative or complementary manner to the provision of a steering setpoint A2, the heading definition device 2 can provide a force data T2, called « steering wheel torque » which corresponds to the force exerted by the driver on said heading definition apparatus 2, and more particularly to the torque exerted by the driver on the steering wheel 2.

Said steering wheel torque T2 can be measured by a torque sensor 9 associated to the steering wheel 2.

Depending in particular on the steering angle setpoint A2 and/or, where appropriate, depending on the « steering wheel torque » T2 exerted by the driver on said heading definition device 2, the assist motor 8 defines, according to an assist law stored in said assist module 8, an assist force setpoint (assist torque setpoint) T7 that it applies to the assist motor 7, in order to coincide the actual steering angle A1 of the system 1, and consequently the yaw angle of the wheels 5, with the orientation defined by the heading definition apparatus 2.

Of course, other parameters, and in particular dynamic parameters of the vehicle, such as the longitudinal speed of the vehicle, can be taken into consideration by the assist law.

It should be noted that the invention can preferably be applied to a power steering system within which the steering wheel 2 is mechanically connected to the rack 4 and therefore mechanically connected, at least indirectly, to the assist motor 7, for example via a steering column 10 carrying said steering wheel 2 and provided with a pinion 11 which meshes with the rack 4.

In this manner, the steering wheel 2 is an integral part of the steering mechanism 3, and can transmit a manual steering force and/or a steering movement to the movable member (rack) 4, and conversely, be driven by the assist motor 7.

Alternatively, it can as well be considered to apply the invention to a power steering system called « steer by wire » system, within which there is no mechanical drive link between the steering wheel 2 and the movable member (rack) driven by the assist motor 7, but only an electrical link which transmits the steering angle setpoint A2 and/or the steering wheel torque information T2 to the assist module 8 which in turn servo-controls the assist motor 7.

The assist motor 7 might be coupled to the rack 4 by any appropriate mechanism, and in particular by a motor pinion 12, possibly distinct from the pinion 11 of the steering column, and which meshes directly on the rack 4, as illustrated in FIG. 1, or by a ball screw, or even via a reducer placed on the steering column 10 to form a mechanism called « single pinion » mechanism.

Whether a mechanical link steering or a steer-by-wire is considered, the heading definition device 2 intervenes during a phase called « control phase », during which the power steering system 1 is effectively assigned to driving a vehicle, in order to make said vehicle follow a trajectory which is determined depending on the situation of said vehicle relative to the environment thereof.

According to the invention, the method comprises, apart from such a control phase, that is to say at a time when the steering system 1, and more generally the vehicle, is outside a traffic situation, and that it is therefore not necessary to take into account the environment of said vehicle to define a vehicle trajectory adapted to such an environment, nor necessary to respect a particular trajectory to ensure the safety of the vehicle and its occupants, a step (a) of automatic activation of the assist motor 7, during which a computer 13 is used to automatically generate and apply to the assist motor 7, without requiring an external action on the heading definition device 2, an activation setpoint which follows one or several cycle(s) called pre-established « scanning cycles » CY, a measurement step (b), according to which, during the scanning cycle(s) CY or at the end of said scanning cycle(s) CY, at least one physical parameter, called « indicator parameter », is measured, which is specific to the response provided by the power steering system 1 upon automatic activation of the assist motor 7 and which is characteristic of the desired property, then an analysis step (c), during which the desired property is quantified from the measurement(s) of the indicator parameter.

Although it is not excluded to occasionally use a computer 13 external to the power steering system 1, which would be electrically connected to said system 1 when it is desired to proceed with the characterization of said system, said computer 13 can preferably be an integral part of the power steering system 1, and therefore of the vehicle equipped with said system 1, and form, to this end, a second on-board module, called « characterization module » 13.

Preferably, the first module, namely the assist module 8 used for the steering assistance during the control phase, and the second module, namely the characterization module 13 intended to monitor the automated process for characterizing the power steering system 1 apart from the control phase will coexist within the same computer on-board the vehicle.

Advantageously, the invention allows intrinsically using the on-board assist motor 7 in the power steering system 1 as an exclusive drive source to drive the steering mechanism 3 during the characterization, without requiring an external active movement source, such as the manual force of an operator or an additional external motor, which would be distinct from the assist motor 7 (and for example integrated into a robotic arm).

More generally, the characterization according to the invention can therefore advantageously be carried out without it being necessary to act mechanically actively, manually or by an external motor, on the power steering system 1, and more particularly on the steering mechanism 3, from the outside, and more particularly without the need to actuate, manually or by an external motor, one of the movable mechanical members, such as the steering wheel 2, an apparent end of the rack 4, or possibly a steering tie rod 6 or a wheel 5 connected to said rack 4, which form a mechanical interface between said power steering system 1, respectively said steering mechanism 3, and the outside thereof.

The animation of the steering mechanism 3 for the characterization according to the invention can therefore be carried out autonomously, easily and at low cost, by exclusively using drive means (assist motor 7), and where appropriate, monitoring means (characterization module 13), intrinsically present in the power steering system 1.

It should be noted that provision may also be made for using one or more passive external load(s), such as for example blocking wedges, springs and/or dampers, which are coupled to one and/or the other of the mechanical interfaces of the power steering system 1 (steering wheel 2 or ends of the rack 4, for example) in order to simulate a particular behavior of the steering system 1 and thus access the desired property.

These external loads will however be passive, that is to say will not intrinsically bring, unlike the assist motor 7, energy to the power steering system, but will rather be used to dissipate all or part of the energy supplied to the steering mechanism 3 by said assist motor 7 or to modify the distribution of said energy over time and through said steering mechanism 3.

As indicated above, the characterization method according to the invention takes place apart from any phase of controlling a vehicle, in a test situation which can be qualified as a « virtual » situation, since said situation does not require the need to respect a particular trajectory or a particular dynamic behavior of the vehicle, and therefore allows characterizing the power steering system 1 as such, separately from the influence of the vehicle, by de-correlating the use of said power steering system 1 from the use of the vehicle itself, and consequently without imposing on the characterization process restrictions related to the safety of said vehicle or of the occupants of said vehicle.

The method according to the invention will thus be particularly adapted for the characterization in the factory, out of circulation, typically on a test bench, of a vehicle equipped with a power steering system 1, or even a power steering system 1 alone, before the assembly of said system 1 on a vehicle, and for example with a power steering system 1 on which the wheels 5, and where appropriate the steering tie rods 6 have not yet been put in place.

Since step (a) of automatic activation for the characterization takes place apart from a vehicle control phase, it will be possible to advantageously control the assist motor 7 by means of an scanning cycle CY, and therefore an activation setpoint, whose nature, shape and duration, defined according to a predetermined activation diagram (« pattern »), will be chosen arbitrarily and freely, so as to be able to highlight, optimally, the desired property, and without having to satisfy a trajectory requirement of a vehicle, and in particular without having to take into consideration the safety of the vehicle, the occupants of said vehicle, or the persons or objects present in the environment of said vehicle.

In practice, it will therefore be possible to define and apply the scanning cycles CY, and more generally the activation setpoint applied to the assist motor 7 during the characterization method, without the need to acquire (and in particular to measure) nor to take into consideration parameters representative of the dynamics specific to the vehicle relative to the environment thereof, that is to say parameters representative of the vehicle's own behavior in a reference frame external to said vehicle, among which in particular the longitudinal speed of the vehicle, the lateral acceleration of said vehicle, the yaw rate of said vehicle, or the distance of the vehicle to an obstacle or to an external marker (for example a white line for delimiting a traffic lane) detected in said external reference frame.

In this manner, said scanning cycles will not be subjected to any restriction linked to such parameters representative of the dynamics of the vehicle, and will not therefore require, in practice, for the definition thereof and the application thereof, any external information uptake linked to such parameters, and in particular any visual information uptake.

Thus, the assist motor 7 could be activated without going through an information uptake concerning parameters representative of the dynamics of the vehicle in the environment thereof, an information uptake which would be carried out either by the senses (in particular tactile and visual) of a human driver, who would then react to this information by manually actuating the steering wheel 2, either by an automatic acquisition process (for example by means of a camera or a radar, in particular laser, infrared or ultrasound) which would be implemented by an automatic control module.

At most, said scanning cycles could possibly be dimensioned so as to respect some material limitations inherent in the design of the power steering system 1 itself, such as for example the maximum torque that the assist motor 7 can deliver (and therefore the maximum electric current that said assist motor 7 can tolerate without damage).

As illustrated in FIG. 2, the scanning cycle might preferably include at least one change of sign, which corresponds to a reversal of the direction of activation of the assist motor 7, so as to activate said assist motor 7 to the right, then to the left (or vice versa).

Thus, a scanning cycle, called « elementary » scanning cycle, might preferably comprise a positive alternation and a negative alternation.

However, of course, alternatively, an elementary cycle might be used comprising a single alternation, of a constant sign, for example positive, in order to bias the assist motor 7 only in one direction, to the right or on the contrary to the left, if that is enough to define the desired property.

Of course, each elementary scanning cycle CY might be repeated as many times as necessary, preferably identically, up to a predetermined number of iterations Ni.

If necessary, the repetition of the scanning cycles CY will allow multiplying, during successive cycles, the measurements of the same indicator parameter, for example at the rate of at least one, or even exactly one, measurement of said indicator parameter per cycle.

By thus using a plurality of successive measurements of the same indicator parameter over several cycles to quantify the desired property, and for example by using, for this purpose, an arithmetic average or a weighted average of the different measurements of said indicator parameter over several cycles, or even a selection of said measurements with exclusion of the values which are considered doubtful, the accuracy and the reliability of the analysis step (c) can be advantageously improved, during which the desired property is quantified from said indicator parameter, respectively from said average.

Of course, during the measurement step (b), the reactions of the power steering system 1, and more particularly of the steering mechanism 3, to the mechanical stresses, created by the activation of the assist motor 7, are observed by measuring and possibly recording as many indicator parameters as necessary to determine the desired property from said observed response.

One or several indicator parameter(s) could in particular be measured, as required, among: the position P7 (and therefore the displacements) of the shaft of the assist motor 7, the position (and therefore the displacements) P4 of the movable member 4 (rack) or the position P2 (and therefore the displacements) of the steering wheel 2, preferably expressed in the reference frame of the assist motor 7, the speed P7′, P4′, P2′, and in particular the angular speed (preferably expressed in the reference frame of the motor 7, by taking into consideration the possible mechanical transmission ratios) of one or the other of these components 7, 4, 2, the force T7 delivered by the assist motor 7, the steering wheel torque T2, or a retaining force T4 exerted by an external element on the movable member (rack) 4 against the assist motor 7.

For simple convenience of description, the suffix « _mes » can be added in the following to explicitly designate an indicator parameter (measured or evaluated) associated to a given magnitude, in particular when it is necessary to explicitly differentiate the effective value measured by said indicator parameter of a corresponding setpoint value. However, for simplicity of description, the indicator parameter (effective measured magnitude), might generally be assimilated to the corresponding setpoint.

Preferably, the method allows determining at least one desired property, and even more preferably several (at least two) desired properties, among:
a rise in temperature or a thermal evolution regime of the assist motor 7,
an endurance property characterized by a wear indicator, such as a degree of wear of the steering mechanism 3 or of the assist motor 7, depending on a number (Ni) of reciprocation cycles carried out by the steering mechanism.

These different possibilities offered by the invention will be detailed below.

According to one possibility of the invention, provision may be made to apply, during the automatic activation step (a), a position scanning cycle CY_pos, which servo-controls the assist motor 7, and consequently the steering mechanism 3, respectively the considered movable member 4 or the steering wheel 2, in position P7, P4, P2, from a first extreme position (« tip position ») Xlow (here a lower position, to the left) to a second extreme position Xupp (here an upper position, on the right) which is distant from the first extreme position.

Preferably, the position cycle CY_pos will servo-control the assist motor 7, and consequently the steering mechanism 3, respectively the considered movable member 4 or the steering wheel 2, in position P7, P4, P2, alternatively, from the first extreme position Xlow to the second extreme position Xupp then, vice versa, from the second extreme position Xupp to the first extreme position Xlow.

As illustrated in FIG. 2, the elementary position scanning cycle CY_pos, which represents the position setpoint P7, P4, P2 applied as a function of time, might comprise a first alternation 40, for example a triangular alternation, which defines a displacement (here to the right) from a starting position (preferably the central position C0) to the second extreme position Xupp, then a return displacement to the starting position, then a second alternation 140 which defines, from the starting position, a displacement to the left, to the first extreme position Xlow, before returning to the starting position.

Preferably, Xlow=−Xupp will be chosen to obtain a symmetrical scanning.

It should be noted that the position setpoints P7, P4, P2, and more particularly the extreme positions Xlow, Xupp, could preferably be expressed as a percentage of the maximum allowable half-stroke L4/2 (typically 0% for the rest phases, and for example at least 20%, preferably at least 50%, and preferably up to 70%, 80%, even 90% for the extreme positions Xlow, Xupp).

The alternations 40, 140 might be preceded and/or followed by a rest phase 41, 42.

The displacement speeds V7, V4, V2, which will correspond to the slopes of the ramps of the broken line, could be freely chosen and programmed, by setting the time marks t1, t2, t3 . . . delimiting the displacement durations depending on the displacement amplitudes Xupp, Xlow.

According to a preferential possibility, a sequence of several successive position scanning cycles CY_pos will be applied, by repeating each elementary position scanning cycle CY_pos (here comprising two alternations 40, 140) a predetermined number of iterations Ni.

According to an application variant, it is possible to use such position scanning cycles CY_pos to carry out an endurance test, during which an elementary position scanning cycle CY_pos will be repeated (corresponding herein to a full round trip between the extreme positions Xlow, Xupp) a predetermined number of iterations Ni, preferably equal to or greater than 250, 1000, 10⁴ (ten thousand), 10⁵ (one hundred thousand), or even 10⁶ (one million), and, during and/or at the end of said iterations Ni, at least one wear indicator parameter will be measured, which is representative of the wear of all or part of the power steering system 1, and more particularly of the steering mechanism 3 and/or the assist motor 7, and therefore representative of an endurance property of the power steering system 1.

Said wear indicator parameter might for example be a loss of material thickness on a mechanical part (indicating the appearance or the increase of a clearance), a permanent modification of a reference dimension on said mechanical part (motor shaft 7, rack 4, or other) by residual plastic deformation, the appearance of microcracks whose maximum size or density (number per unit volume of a mechanical member, such as the motor shaft 7, the rack 4, or other) exceeds a predefined alert threshold, the electrical resistance value of the windings of the assist motor 7, the temperature (the temperature drift) of the assist motor 7, etc.

Preferably, during an endurance test, the steering mechanism 3, and more particularly one and/or the other of the ends of the rack 4, could be coupled to a passive load forming a damping device, such as a spring, an elastomer block, or a hydraulic cylinder, intended to dissipate at least one portion of the energy imparted to the mechanism 3 by the assist motor 7, in order to prevent the mechanism 3 from operating « in a vacuum » with an increased risk of impact at the end of stroke.

According to another application variant, such a succession of several position scanning cycles CY_pos can be used, instead of a force scanning cycle CY_force, to carry out a thermal test of the assist motor 7.

For this purpose, it will be possible, for example, to measure, as an indicator parameter, the temperature of the assist motor 7, in order to determine for example the maximum temperature reached during, or at the end of the predetermined number of iterations Ni.

In order to carry out such a thermal test based on an elementary position scanning cycle CY_pos, a number of iterations Ni equal to or greater than 5, equal to or greater than 10, equal to or greater than 100, even equal to or greater 4000, will preferably be used.

Conversely, according to yet another variant of application, it will be possible to use a series of a large number of consecutive force scanning cycles CY_force, typically more than Ni=10³, more than Ni=10⁴, more than Ni=10⁵, or even more Ni=10⁶ cycles (iterations), rather than position scanning cycles, to carry out an endurance test of the steering system 1.

During such an endurance test, one or more wear indicator parameters may be supervised as described above.

Such endurance tests based on a force scanning cycle CY_force can be carried out either with the steering wheel 2 and the rack 4 being free, or, preferably, with the steering wheel 2 blocked and/or the rack 4 blocked.

Moreover, the characterization method might also include, during the activation step (a), a security sub-step (a1), during which the motor torque setpoint T7 applied to the assist motor 7 is clipped, in order to maintain said torque setpoint below (in absolute value) a predetermined safety threshold T7_safe, said safety threshold T7_safe being adjusted, and more particularly reduced, when being in an approach phase of a limit position Xlim which one wishes not to exceed, and for example when being in the approach phase of an end-of-stroke stop S1, S2.

To this end, a function called « security function » is used which defines, as illustrated in FIG. 3, in a reference frame associating a steering wheel torque T7 (on the ordinate) to a value representative of the position P7, P4, P2 of the steering mechanism, and more preferably representative of the position P4 of the rack 4, on the one hand, an authorized domain D1 (blank in FIG. 3) and, on the other hand, a prohibited domain D2 (hatched in FIG. 3) , whose border corresponds to the safety threshold T7_safe.

It should be noted that, in each considered direction of displacement (to the right, respectively to the left), the safety threshold T7_safe is lowered (that is to say that the absolute value thereof decreases), from a safety position Xsafe which precedes the limit position Xlim in the considered direction of displacement, and preferably until being canceled when reaching said limit position Xlim.

For this purpose, the security function can form a decreasing ramp from the safety position Xsafe to the limit position Xlim.

Thus, it is possible to force a gradual slowing down of the steering mechanism 3 in order to avoid exceeding the limit position Xlim, and more particularly an impact against the stop S1 (when the used scanning cycle does not aim at determining the position of said stop, of course), when approaching said limit position Xlim.

However, since it is not necessary to brake the mechanism 3 when moving away from the limit position Xlim, the safety threshold T7_safe might return directly to its maximum value (plateau value), as illustrated by the rectangular corner shaped border of the authorized domain D1 in FIG. 3.

The limit position Xlim is preferably defined as a percentage, for example comprised between 75% and 100%, and more particularly between 80% and 95% of the position of the corresponding end-of-stroke stop S1, S2.

Of course, the invention also concerns, as such, a power steering system 1 allowing implementing all or part of the aforementioned characterization methods.

The invention thus concerns more particularly a power steering system 1 which comprises a characterization module 13 forming a complete characterization « toolbox », containing and allowing selectively implementing a scanning cycle and this in particular in order to facilitate the automatic calibration and the development of the system 1 in the factory.

Thus, the invention concerns a power steering system 1 intended to equip a vehicle and comprising at least one heading definition device 2, such as a steering wheel, which allows a driver to define a steering angle A1 of the power steering system, a steering mechanism 3 provided with at least one movable member 4, such as a rack, whose position P4 is adapted so as to correspond to the chosen steering angle A1, as well as at least one assist motor 7 arranged to be able to drive said steering mechanism 3, said power steering system 1 including, on the one hand, a first on-board module 8, called « assist module » 8, which contains a first set of functions called « assist laws », which allow generating, when the power steering system 1 is assigned to driving a vehicle, control setpoints to the assist motor 7, in order to make said vehicle follow a trajectory which is determined depending on the situation of said vehicle relative to its environment, and on the other hand, a second on-board module 13, called « characterization module » 13, which contains a second set of functions, called « characterization functions », distinct from the assist laws, and which allow implementing, during a period when the power steering system is not assigned to driving a vehicle, and automatically, a characterization method intended to empirically determine at least one property of said power steering system, called « desired property ».

Just like the assist module 8, the characterization module 13 is preferably an electronic or computer module.

As indicated above, said characterization method comprises a step (a) of automatic activation of the assist motor 7, during which the second on-board module 13 automatically generates and applies to the assist motor 7, without requiring an external action on the heading definition device 2, an activation setpoint T7, V7, P7 which follows one or several cycle(s) called pre-established « scanning cycles » CY, in order to allow a measurement step (b), according to which, during the scanning cycle(s) CY or at the end of said scanning cycle(s) CY, at least one physical parameter, called « indicator parameter » P7_mes, T7_mes, P4_mes, T2_mes, V2_mes, etc., is measured, which is specific to the response provided by the power steering system 1 upon automatic activation of the assist motor 7 and which is characteristic of the desired property, then an analysis step (c), during which the desired property is quantified from the measurement(s) of the indicator parameter.

The characterization module 13, as well as the assist module 8, will therefore preferably be integrated into the steering system 1, and in particular integrated into an on-board calculation module which can be used autonomously.

The characterization functions, and more particularly the scanning cycles CY that these characterization functions automatically implement, can advantageously be stored in a non-volatile memory of the characterization module 13, for example in the form of function libraries (dll files) programmed in said characterization 13 and/or map module.

The characterization module 13 will thus contain a plurality of pre-established scanning cycles CY, so as, for example, to allow selectively activating, apart from a vehicle control phase, a cycle CY selected from the scanning cycles described above.

Preferably, the second on-board module (characterization module) 13 groups an endurance characterization function which uses a succession of position scanning cycles CY_pos in order to subject, under the effect of the assist motor 7, the steering mechanism 3 to a succession of reciprocation movements between a first extreme position Xlow and a second extreme position Xupp, in order to generate a fatigue wear of said mechanism and said assist motor.

The characterization module 13 will preferably also comprise a selector allowing selecting and executing one or the other of said available characterization functions, separately from the other characterization functions and the assist functions, and thus automatically and autonomously controlling the assist motor 7 for a characterization, independently of the control of the vehicle.

Of course, the invention is in no way limited to the sole variants described above, those skilled in the art being in particular in position to isolate or freely combine together the aforementioned features, or to replace them with an equivalent.

1. A method for a power steering system to empirically determine at least one property of said power steering system, called « desired property », said power steering system comprising at least one heading definition device, which allows defining the orientation, called « steering angle » of the power steering system, a steering mechanism provided with at least one movable member, whose position is adapted so as to correspond to the chosen steering angle, as well as at least one assist motor arranged to be able to drive said steering mechanism, said method comprising, apart from a control phase during which the power steering system is assigned to driving a vehicle in order to make said vehicle follow a trajectory which is determined depending on the situation of said vehicle relative to its environment, a step (a) of automatic activation of the assist motor, during which a computer is used to automatically generate and apply to the assist motor, without requiring an external action on the heading definition device, an activation setpoint which follows one or several cycle(s) called pre-established « scanning cycles », a measurement step (b), according to which, during the scanning cycle(s) or at the end of said scanning cycle(s), at least one physical parameter, called « indicator parameter », is measured, which is specific to the response provided by the power steering system upon automatic activation of the assist motor and which is characteristic of the desired property, then an analysis step (c), during which the desired property is quantified from the measurement(s) of the indicator parameter, wherein during the automatic activation step (a), a position scanning cycle is applied, which servo-controls the assist motor, and consequently the steering mechanism, in position, from a first extreme position to a second extreme position distant from the first position.

2. The method according to claim 1, wherein the position scanning cycle is repeated a predetermined number of iterations, and at least one fatigue indicator parameter is measured, which is representative of the wear of all or part of the power steering system.

3. The method according to claim 1, wherein it allows determining at least one desired property among:
a rise in temperature or a thermal evolution regime of the assist motor,
an endurance property including a wear indicator depending on a number of reciprocation cycles carried out by the steering mechanism.

4. A power steering system to equip a vehicle and comprising at least one heading definition device, which allows a driver to define a steering angle of the power steering system, a steering mechanism provided with at least one movable member, whose position is adapted so as to correspond to the chosen steering angle, as well as at least one assist motor arranged to be able to drive said steering mechanism, said power steering system including, on the one hand, a first on-board module, called « assist module », which contains a first set of functions called « assist laws », which allow generating, when the power steering system is assigned to driving a vehicle, control setpoints to the assist motor, in order to make said vehicle follow a trajectory which is determined depending on the situation of said vehicle relative to its environment, and on the other hand, a second on-board module, called « characterization module », which contains a second set of functions, called « characterization functions », distinct from the assist laws, and which allow implementing, during a period when the power steering system is not assigned to driving a vehicle, and automatically, a characterization method intended to empirically determine at least one property of said power steering system, called « desired property », said characterization method comprising a step (a) of automatic activation of the assist motor during which the second on-board module automatically generates and applies to the assist motor, without requiring an external action on the heading definition device, an activation setpoint which follows one or several cycle(s) called pre-established « scanning cycles », in order to allow a measurement step (b), according to which, during the scanning cycle(s) or at the end of said scanning cycle(s), at least one physical parameter, called « indicator parameter », is measured, which is specific to the response provided by the power steering system upon automatic activation of the assist motor and which is characteristic of the desired property, then an analysis step (c), during which the desired property is quantified from the measurement(s) of the indicator parameter, wherein during the automatic activation step (a), a position scanning cycle is applied, which servo-controls the assist motor, and consequently the steering mechanism, in position, from a first extreme position to a second extreme position distant from the first position.

5. The power steering system according to claim 4, wherein the second on-board module includes an endurance characterization function which uses a succession of position scanning cycles in order to subject, under the effect of the assist motor, the steering mechanism to a succession of reciprocating movements between a first extreme position and a second extreme position, in order to generate a fatigue wear of said mechanism and said assist motor.

6. The method according to claim 2, wherein it allows determining at least one desired property among:
a rise in temperature or a thermal evolution regime of the assist motor,
an endurance property including a wear indicator depending on a number of reciprocation cycles carried out by the steering mechanism.
